(19) United States
(12) Patent Application Publication
(10) Pub. No.: US 2021/0317285 A1
(43) Pub. Date: Oct. 14, 2021

(54) FLUOROPOLYMER POWDER HAVING AN EXTENDED SINTERING WINDOW USING HEAT TREATMENT, AND USE THEREOF IN LASER SINTERING

(71) Applicant: ARKEMA FRANCE, COLOMBES (FR)

(72) Inventors: Stephane BIZET, Barc (FR); Thomas Pierre Brossier, Lys-Haut-Layon (FR)

(21) Appl. No.: 16/956,818

(22) PCT Filed: Jan. 14, 2019
(86) PCT No.: PCT/FR2019/050069

§ 371 Date: Jun. 22, 2020

(30) Foreign Application Priority Data
Jan. 15, 2018 (FR) 1850294

(51) Int. Cl. C08K 3/36; B33Y 10/00; B33Y 70/00; B29C 64/153

(52) U.S. Cl. CPC C08K 3/36; B33Y 10/00; B29K 2027/12; B29C 64/153; B33Y 70/00

(57) ABSTRACT

The invention relates to a composition based on a thermoplastic fluoropolymer powder, in particular on polyvinylidene fluoride (PVDF) with improved flowability, particularly suitable for manufacturing parts by 3D laser sintering. The invention also relates to a method for agglomerating powder layer by layer, by melting or sintering using said composition. The invention finally relates to a three-dimensional article obtained by implementing said method.

### FIELD OF THE INVENTION

The present invention relates to a fluoropolymer powder additivated with a flow agent and heat-treated in the presence of the flow agent. The invention also relates to a process for agglomeration of powder, layer by layer, by melting or sintering using said composition. The invention lastly relates to a three-dimensional object obtained by the implementation of this process.

### TECHNICAL BACKGROUND

The agglomeration of powders by melting (hereinafter referred to as “sintering”) is obtained by radiation, such as, for example, a laser beam (laser sintering), infrared radiation, UV radiation, or any source of electromagnetic radiation which makes it possible to melt the powder layer by layer in order to manufacture objects. Laser-beam powder sintering technology is used to manufacture three-dimensional objects, such as prototypes or models but also functional parts, in particular in the motor vehicle, nautical, aeronautical, aerospace, medical (prostheses, auditory systems, cell tissues, and the like), textile, clothing, fashion, decorative, electronic casing, telephony, home automation, computing or lighting fields.

A thin layer of powder of the polymer in question is deposited on a horizontal plate maintained in a chamber heated to a certain temperature. The laser supplies the energy required to fuse the powder particles at various points of the layer of powder in a geometry corresponding to the object, for example using a computer that stores the shape of the object and that reproduces this shape in the form of slices. Next, the horizontal plate is lowered by a value corresponding to the thickness of one layer of powder (for example between 0.05 and 2 mm and generally of the order of 0.1 mm), then a new layer of powder is deposited. This layer of powder is at a temperature referred to subsequently as the temperature of the powder bed (or temperature of the bed). The laser supplies the energy required to fuse the powder particles in a geometry corresponding to this new slice of the object and so on. The procedure is repeated until the entire object has been manufactured. Besides the melting of the powder particles induced by the energy supplied by the laser, it is necessary to use conditions that enable the coalescence of the particles with one another and a good adhesion/coalescence of the layers with one another so that the mechanical properties of the objects manufactured are maximized.

In the case of semicrystalline polymers, the transformation window (temperature range of the powder bed) is between the crystallization temperature (Tc) and the melting temperature (Tm) of the polymer considered. If the temperature of the powder bed is too close to Tm, then there is agglomeration (caking) of the powder outside of the zone constituting the object, hence a loss of material and of precision in the definition of the geometry of the part.

To facilitate the laser sintering process, it is desirable for the polymer to have the widest possible sintering window and a narrow melting range. As a first approximation, the sintering window may be defined as the difference between the onset of melting temperature (T_{m,onset}) and the onset of crystallization temperature (T_{c,onset}). During the sintering process, the powder bath is brought to a temperature (T_{bath}) within this range. When T_{bath} is too close to T_{c,onset}, defects in the geometry of the parts may appear (warping, poor inter-layer coalescence along the axis of construction) owing to excessively fast crystallization of the polymer. Conversely, when T_{bath} is too close to the onset of melting temperature, the phenomenon of agglomeration of the powder becomes predominant. A large amount of powder not exposed to the laser remains bonded to the surface of the parts or clogs porosities of the part. A wide sintering window enables an easier use of the material since this material more readily tolerates the temperature gradients present within the sintering machine in the construction tank.

There is therefore a need to have a powder which has a low tendency to agglomerate. Such a powder makes it possible to work at bath temperatures close to the melting temperature of the polymer (temperature at the peak) without having the problem of agglomeration. On the one hand, this makes it possible to envisage using lower energy densities to melt the fluoropolymer during the sintering process. On the other hand, this makes it possible to work in a temperature range where the crystallization kinetics of the semicrystalline polymer are slow which is favorable to the development of a good adhesion between two successive deposited polymer layers.

### SUMMARY OF THE INVENTION

The invention relates to a thermoplastic fluoropolymer powder composition suitable for the manufacture of parts by the 3D laser sintering process with an enlarged sintering window. The sintering window is enlarged by performing a heat treatment of the powder in order to increase the degree of crystallinity and the onset of melting temperature. The heat treatment makes it possible to shift the appearance of the agglomeration phenomenon to higher temperatures and to densify the powder. The heat treatment is particularly effective when it is carried out on a thermoplastic fluoropolymer powder additivated with a flow agent.

The invention relates firstly to a composition in powder form comprising a thermoplastic fluoropolymer and a flow agent. Characteristically, the composition of the invention has been treated by heating at a temperature ranging from Tₘ−40° C. to Tₘ−5° C., Tₘ being the melting temperature of the thermoplastic polymer defined as the temperature at which the heat flow measured by DSC passes through a maximum in the melting zone of the polymer.

The fluoropolymer contains in its chain at least one monomer chosen from the compounds containing a vinyl group capable of opening in order to polymerize and which contains, directly attached to this vinyl group, at least one fluorine atom, a fluoroalkyl group or a fluoroalkoxy group.

According to one embodiment, the fluoropolymer is a polymer comprising units derived from vinylidene fluoride, and is preferably chosen from polyvinylidene fluoride homopolymer and copolymers comprising vinylidene fluoride units and units derived from at least one other comonomer copolymerizable with vinylidene fluoride.

According to one embodiment, the fluoropolymer has a viscosity of less than or equal to 1600 Pa·s, preferably of less than or equal to 1000 Pa·s, at a temperature of 232° C. and at a shear rate of 100 s⁻¹.

The composition of the invention further comprises a flow agent in a sufficient amount for the composition to flow and to form a flat layer, in particular during a layer-by-layer sintering process.

The flow agent is, for example, chosen from: precipitated silicas, fumed silicas, vitreous silicas, pyrogenic silicas, vitreous phosphates, vitreous borates, vitreous oxides, amorphous alumina, titanium dioxide, talc, mica, kaolin, attapulgite, calcium silicates, alumina and magnesium silicates.

According to one embodiment, the flow agent is a hydrophobic silica.

Another subject of the present invention is the use of a thermoplastic powder composition as defined above, in a sintering process for manufacturing a three-dimensional object.

One subject of the present invention is in particular a process for manufacturing a three-dimensional object, comprising the layer-by-layer sintering of a powder with a composition according to the invention.

Finally, the present invention relates to a three-dimensional object capable of being manufactured according to the process described above.

The present invention makes it possible to overcome the drawbacks of the prior art. It provides a fluoropolymer powder with good flowability and a bulk density increased by additivation of silica. It provides more particularly a composition having a good flowability and the good density enabling the use thereof via the process of sintering under electromagnetic radiation without leading to an agglomeration of the powder. This is accomplished owing to the heat treatment which shifts the propensity of the powder to agglomerate to high temperatures. The fluoropolymer is chosen with respect to its viscosity which should be low enough to facilitate the coalescence and the inter-diffusion of the chains between layers at the temperature of the powder bath. The criterion for choosing the fluoropolymer may therefore be the viscosity at zero shear gradient at the powder bed temperature, which is typically of the order of 150° C. for PVDF. The fact of having a good flowability, a good density and a good quality of the powder bed, and a suitable viscosity of the polymer makes it possible to work under standard process conditions (energy density of the laser, number of passes of the laser per layer) without risking degrading the fluoropolymer and generating hydrofluoric acid during the manufacture of the part.

It is particularly suitable for the manufacture of three-dimensional objects.

### BRIEF DESCRIPTION OF THE FIGURES

FIG. 1 is a diagram representing the variation of the compressive force as a function of the temperature, for various PVDF-based powder compositions.

### DESCRIPTION OF EMBODIMENTS OF THE INVENTION

The invention is now described in more detail and in a nonlimiting manner in the description which follows.

According to a first aspect, the invention relates to a pulverulent composition suitable for laser sintering comprising a thermoplastic fluoropolymer and a flow agent, that has undergone heating at a temperature ranging from Tₘ−40° C. to Tₘ−5° C., preferably at a temperature ranging from Tₘ−30° C. to Tₘ−5° C. This treatment makes it possible to reduce the propensity of the powder to agglomerate. This agglomeration tendency is evaluated according to a compression test carried out on the powder that has undergone the heat treatment. More specifically, the test consists in filling hollow metal cylinders having an internal diameter of 15 mm and a height of 2 cm with the test powder. The metal cylinders act as a mold. Once filled, the cylinders are placed in an oven at the temperature for evaluating the caking for a given time, for example 8 hours. The cylinders are taken out of the oven and left to cool to ambient temperature. Next, a powder “cake” is obtained by removing the metal cylinder. This powder cake is then placed between the jaws of a universal testing machine in order to undergo a compression test. The compressive force is recorded as a function of the displacement of the jaws. The maximum force reached during the compression test is recorded. Advantageously, the composition thus treated has a compressive force of less than 2 N, preferably less than or equal to 1.5 N. The melting temperature of the thermoplastic polymer is measured by differential scanning calorimetry (DSC) at 20° C./min. The melting temperature corresponds to the temperature of the maximum of the heat flow in the melting zone of the polymer.

According to various embodiments, said composition comprises the following features, if need be combined.

The invention is based first on the use of a fluoropolymer. A fluoropolymer is understood to mean a polymer comprising —F groups. The fluoropolymer contains in its chain at least one monomer chosen from the compounds containing a vinyl group capable of opening in order to polymerize and which contains, directly attached to this vinyl group, at least one fluorine atom, a fluoroalkyl group or a fluoroalkoxy group. Mention may be made, as an example of a monomer, of vinyl fluoride; vinylidene fluoride (VDF); trifluoroethylene (VF3); chlorotrifluoroethylene (CTFE); 1,2-difluoroethyl ene; tetrafluoro ethyl en e (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the product of formula CF₂═CFOCF₂CF(CF₃)OCF₂CF₂X wherein X is SO₂F, CO₂H, CH₂OH, CH₂OCN or CH₂OPO₃H; the product of formula CF₂═CFOCF₂CF₂SO₂F; the product of formula F(CF₂)nCH₂OCF═CF₂ wherein n is 1, 2, 3, 4 or 5; the product of formula R₁CH₂OCF═CF₂ wherein R₁ is hydrogen or F(CF₂)ₘ and m is equal to 1, 2, 3 or 4; the product of formula R₂OCF═CH₂ wherein R₂ is F(CF₂)p and p is 1, 2, 3 or 4; perfluorobutyl ethylene (PFBE); 3,3,3-trifluoropropene and 2-trifluoromethyl-3,3,3-trifluoro-1-prop ene.

The fluoropolymer may be a homopolymer or a copolymer, it may also comprise non-fluorinated monomers such as ethylene.

According to one embodiment, the fluoropolymer is a homopolymer of one of the following monomers: vinyl fluoride, vinylidene fluoride, chlorotrifluoroethylene or tetrafluoroethylene.

According to one embodiment, the fluoropolymer is chosen from copolymers of ethylene and chlorotrifluoroethylene, of ethylene and tetrafluoroethylene, of hexafluoropropylene and tetrafluoroethylene, of tetrafluoroethylene and a monomer from the family of perfluoro(alkyl vinyl) ethers.

According to one embodiment, the fluoropolymer is a polymer comprising units resulting from vinylidene fluoride and is preferably chosen from polyvinylidene fluoride homopolymer and copolymers comprising vinylidene fluoride units and units derived from at least one other comonomer chosen from: vinyl fluoride; trifluoroethylene; chlorotrifluoroethylene; 1,2-difluoroethylene; tetrafluoroethylene; hexafluoropropylene; perfluoro(alkyl vinyl) ethers such as perfluoro(methyl vinyl) ether, perfluoro(ethyl vinyl) ether and perfluoro(propyl vinyl) ether; perfluoro(1,3-dioxole); perfluoro(2,2-dimethyl-1,3-dioxole), and mixtures thereof. Preferably, the fluorinated comonomer is chosen from chlorotrifluoroethylene, hexafluoropropylene, trifluoroethylene and tetrafluoroethylene, and mixtures thereof. In a variant, the copolymer comprises only VDF and HFP. More particularly preferably, the copolymers contain at least 50 mol % of units derived from vinylidene fluoride, and more preferably still at least 75 mol % of units derived from vinylidene fluoride.

According to one embodiment, the fluoropolymer is a terpolymer of ethylene, hexafluoropropylene and tetrafluoroethylene, or a terpolymer of tetrafluoroethylene, vinylidene fluoride and propylene hexafluoride.

“Thermoplastic” is understood here to mean a nonelastomeric polymer. An elastomeric polymer is defined as being a polymer which can be drawn, at ambient temperature, to twice its initial length and which, after releasing the stresses, rapidly resumes its initial length, to within about 10%, as indicated by the ASTM in the Special Technical Publication, No. 184.

According to one embodiment, the fluoropolymer has a viscosity of less than or equal to 1600 Pa·s, preferably of less than or equal to 1000 Pa·s, at a temperature of 232° C. and at a shear rate of 100 s⁻¹. The viscosity is measured at 232° C., at a shear rate of 100 s⁻¹, using a capillary rheometer or a parallel-plate rheometer, according to the standard ASTM D3825. According to one embodiment, which may be combined with the one described in the preceding paragraph, the fluoropolymer has a viscosity at zero shear gradient at the temperature of the powder bed of less than or equal to 75 000 Pa·s, preferentially less than 25 000 Pa·s and more preferentially still less than 15 000 Pa·s. The method used for measuring the viscosity at zero shear gradient at the temperature of the powder bed is the following. The viscosity is measured using a plate/plate rheometer at three temperatures, above the melting temperature of the fluoropolymer. Typically, the viscosity is measured at three temperatures T₁, T₂, T₃ such that T₁<T₂<T₃ and T₁ is above the melting temperature of the fluoropolymer. At each temperature, the viscosity is measured over a range of angular frequencies. For a given temperature, the viscosity becomes independent of the angular frequency below a critical angular frequency and reaches a plateau which corresponds to the value of the viscosity at zero shear gradient. The temperature T₁ and the measurement range of angular frequencies are chosen so as to achieve the viscosity at zero shear gradient. The viscosity at zero shear gradient at the temperature of the powder bed is then obtained by extrapolation of the straight line representing the logarithm of the viscosity at zero shear gradient as a function of the reciprocal of the temperature in degrees Kelvin. For example, in the case where the fluoropolymer is a vinylidene fluoride homopolymer or a copolymer of vinylidene fluoride and hexafluoropropylene, the temperatures typically chosen for the viscosity measurement are 190° C., 210° C., 230° C. and the angular frequencies are typically between 0.1 rad/s and 100 rad/s.

In the case where the fluoropolymer is polyvinylidene fluoride, the fluoropolymer may be a blend of two or more vinylidene fluoride homopolymers having different viscosities. The viscosity of the blend, measured at 232° C. and 100 s⁻¹, is less than or equal to 1600 Pa·s.

In the case where the fluoropolymer is a copolymer of vinylidene fluoride and at least one other comonomer listed above, the fluoropolymer may be a blend of two or more copolymers having different viscosities. The viscosity of the blend, measured at 232° C. and 100 s⁻¹, is less than or equal to 1600 Pa·s.

The fluoropolymer powder has a particle size defined by a Dv50 of less than or equal to 100 μm, precisely between 25 and 80 micrometers.

The Dv50 referred to here is the median diameter by volume, which corresponds to the value of the particle size which divides the population of particles examined exactly into two. The Dv50 is measured according to the standard ISO 9276 parts 1 to 6. In the present description, a Malvern INSITEC System particle size analyzer is used and the measurement is carried out by the dry route by laser diffraction on the powder.

The fluoropolymer used in the invention can be obtained by known polymerization methods, such as solution, emulsion or suspension polymerization. According to one embodiment, it is prepared by an emulsion polymerization process in the absence of a fluorinated surfactant.

The fluoropolymer used in the invention preferably exhibits a number-average molecular mass ranging from 5 kDa to 200 kDa, preferably from 5 kDa to 150 kDa, more preferentially still from 5 kDa to 120 kDa, as measured by size exclusion chromatography in DMSO/0.1 M NaNO₃ with polymethyl methacrylate as calibration standard.

Such a fluoropolymer of low molecular mass can be obtained in particular by using a high content of one or more chain-transfer agents during the polymerization process. According to one embodiment, chain-transfer agents suitable for this purpose are chosen from:
short-chain hydrocarbons, such as ethane and propane,
esters, such as ethyl acetate and diethyl maleate,
alcohols, carbonates, ketones,
halocarbons and hydrohalocarbons, such as chlorocarbons, hydrochlorocarbons, chlorofluorocarbons and hydrochlorofluorocarbons,
organic solvents, when they are added to an emulsion or suspension polymerization reaction.

Other factors which promote the production of low molecular weight polymers are carrying out the polymerization reaction at high temperatures or else the use of high levels of initiator.

The fluoropolymer used in the invention, when it is a copolymer, may be homogeneous or heterogeneous, and preferably homogeneous. A homogeneous polymer has a uniform chain structure, the statistical distribution of the comonomers not varying between the polymer chains. A homogeneous copolymer can be prepared by a single-step process, in which the comonomers are gradually injected while keeping a weight ratio between them constant. In a heterogeneous copolymer, the polymer chains have an average comonomer content distribution of multimodal or spread-out type; it thus comprises polymer chains rich in a comonomer and polymer chains poor in said comonomer. An example of heterogeneous PVDF appears in the document WO 2007/080338.

The composition of the invention further comprises a flow agent in a sufficient amount for the composition to flow and to form a flat layer, in particular during a layer-by-layer sintering process.

The flow agent is, for example, chosen from: precipitated silicas, fumed silicas, vitreous silicas, pyrogenic silicas, vitreous phosphates, vitreous borates, vitreous oxides, amorphous alumina, titanium dioxide, talc, mica, kaolin, attapulgite, calcium silicates, alumina and magnesium silicates. Furthermore, preferentially, the flow agent has undergone a chemical surface modification so as to give it a hydrophobic character. For example, the flow agent is a hydrophobic fumed silica.

The flow agent has a particle size such that the Dv50 is less than 20 μm.

According to one embodiment, the flow agent is a hydrophobic silica. The silica may be rendered hydrophobic by grafting hydrophobic groups to the silanol functions present at the surface. It has been shown that a hydrophilic silica (not surface-treated) does not improve the flow properties of a PVDF powder. Without addition of silica, the PVDF powder does not flow well enough to be able to be sintered.

To obtain an improved flowability of the fluoropolymer during the sintering process, it is necessary to use an optimal content of flow agent, which depends on the nature of this flow agent and the particle size distribution thereof.

It has been observed that a fluoropolymer powder additivated with 0.4% of hydrophobic silica has a flowability greater than that of a non-additivated powder, but lower than that of a powder additivated with 0.2% of silica. The powder additivated with 0.4% of hydrophobic silica may still be “sintered” but the sintering window of the powder is narrower, i.e. the powder bed temperature range which allows a correct sintering of the powder becomes very narrow and difficult to zero in on.

The composition of the invention comprises a content of flow agent ranging from 0.01% to 5% by weight of the composition, preferably ranging from 0.025% to 1%.

Preferably, the flow agent is of spherical shape.

According to one embodiment, the composition of the invention consists of a fluoropolymer and a flow agent, as described.

According to another embodiment, the composition of the invention further comprises at least one additive suitable for the polymer powders used in sintering, chosen in particular from additives that help to improve the properties of the powder for the use thereof in agglomeration technology and/or additives that make it possible to improve the mechanical (breaking stress and elongation at break) or esthetic (color) properties of the objects obtained by melting. The composition of the invention may in particular comprise dyes, pigments for coloring, pigments for infrared absorption, carbon black, fire-retardant additives, glass fibers, carbon fibers, etc. These additives are in powder form with a Dv50 of less than 20 μm. The compositions of the invention may further contain at least one additive chosen from antioxidant stabilizers, light stabilizers, impact modifiers, antistatic agents, flame retardants, and mixtures thereof. The total content of additives is less than or equal to 50% by weight of the composition.

The fluoropolymer powder may be obtained by various processes. The powder may be obtained directly by an emulsion or suspension synthesis process by drying by spray drying or by freeze drying. The powder may also be obtained by milling techniques, such as cryomilling. The fluoropolymer powder has a particle size characterized by a diameter Dv50 of less than or equal to 100 μm. At the end of the powder manufacturing step, the particle size can be adjusted and optimized for the process of sintering under electromagnetic radiation by selection or screening methods.

The flow agent is added to the fluoropolymer powder and mixed. When the composition also comprises an additive, this additive is added in the melt state using conventional means for mixing thermoplastic polymers such as co-rotating or counter-rotating double-screw or single-screw extruders or co-kneaders.

As regards the heat treatment of the composition, it is possible to use isothermal treatments at the annealing temperature or successive temperature holds or a temperature ramp. The treatment time is from 10 minutes to several hours at the maximum annealing temperature. In the case where the fluoropolymer is a vinylidene fluoride homopolymer obtained by an emulsion synthesis process, the temperature window of the heat treatment is advantageously between 140° C. and 165° C. and more advantageously still between 140° C. and 160° C. In the case where the fluoropolymer is a vinylidene fluoride homopolymer obtained by a suspension synthesis process, the temperature window of the heat treatment is advantageously between 145° C. and 170° C. and more advantageously still between 145° C. and 165° C.

The heat treatment may be carried out “statically” by placing the powder in a container in an oven, or dynamically using a rotatable heating system for example.

Another subject of the present invention is the use of a thermoplastic powder composition as defined above, in a sintering process for manufacturing a three-dimensional object.

One subject of the present invention is in particular a process for manufacturing a three-dimensional object, comprising the layer-by-layer sintering of a powder with a composition according to the invention. According to one embodiment, said process uses laser sintering, the principles of which are described in documents U.S. Pat. No. 6,136,948, WO96/06881 and US20040138363, and comprises the following steps:
a) depositing a thin layer of powder of the composition of the invention on a horizontal plate maintained in a chamber heated to a certain temperature;
b) melting, via the energy supplied by a laser, the powder particles at various points of the layer of powder in a geometry corresponding to the object, for example using a computer that stores the shape of the object and that reproduces this shape in the form of slices;
c) lowering the horizontal plate by a value corresponding to the thickness of one layer of powder, for example between 0.05 and 2 mm and generally of the order of 0.1 mm;
d) depositing a new layer of powder. This layer is at a temperature referred to as the temperature of the powder bed (or temperature of the bed);
e) melting this new layer by the energy supplied by the laser in a geometry corresponding to this new slice of the object;
f) repeating the procedure of steps c), d) and e) until the entire object has been manufactured;
g) cooling the assembly at the end of the complete manufacturing of the object;
h) separating the manufactured object from the surrounding powder that has not been melted.

The present invention also relates to a three-dimensional object capable of being manufactured according to the process described above.

The use of a heat-treated composition according to the invention makes it possible to shift the propensity of the fluoropolymer powder to agglomerate to high temperatures. This effect is even more pronounced when the powder has been additivated with a flow agent, in particular a hydrophobic flow agent.

The advantages obtained are:
an increase in the onset of agglomeration (caking) temperature of the thermoplastic fluoropolymer powder;
an improvement in the flowability of the powder at ambient temperature and at the temperature of the sintering process;
an increase in the tapped density and bulk density;
the improvement of the properties of the sintered parts.

Furthermore, the combination of a polyvinylidene fluoride or of a vinylidene difluoride copolymer having a suitable viscosity and of the additivation of the PVDF powder with a hydrophobic silica enables the sintering of the PVDF powder with standard process parameters. For example, this makes it possible to use irradiation energy densities of the order of from 25 to 45 mJ/mm² in a single scan for a Formiga P100 sintering machine from EOS. The parts obtained have a good geometry and satisfactory mechanical properties. The crystallinity and the molar masses of the PVDF are preserved at the end of the sintering process in the manufactured parts.

### Examples

The following examples illustrate the invention without limiting it.

Products:

PVDF: Vinylidene difluoride homopolymer which has a melt viscosity, measured at 230° C. and 100 s⁻¹, of 250 Pa·s.

Flow agent 1 (FA1): The flow agent FA1 is a fumed silica from Cabot sold under the name Carb-o-sil TS610. The surface was modified with dimethyldichlorosilane in order to give it a hydrophobic character. It has a diameter Dv50 of less than 20 μm.

Flow agent 2 (FA2): The flow agent FA2 is a hydrophilic fumed silica from Cabot sold under the name Carb-o-sil M5. It has a diameter Dv50 of less than 20 μm.

Preparation of the PVDF Powder:

The PVDF powder was prepared by 2-step cryomilling with a Netzch CUM 150 mill. The first step consisted of a cryogenic pre-milling of granules. For this step, the mill is equipped with pin disks having a diameter of 5 mm. The speed of rotation of the disks is set at 14 000 rpm. The powder thus obtained is then cryomilled a second time on the same Netzch mill but equipped with a blast rotor and with a grid in the milling chamber of 100 μm. The speed of the rotor is set at 12 000 rpm, the throughput at 5 kg/h. The powder obtained has a particle size distribution characterized by a DV50 of 50 μm.

The PVDF powder was then mixed with the flow agents FA1 or FA2 in a proportion of 0.2% by weight using a MAGIMIX food processor type mixer at high speed for 110 seconds.

Characterization of the Properties of the PVDF Powder:

Particle size distribution: The particle size distribution was measured by the dry route using a Malvern INSITEC System laser particle size analyzer.

Flowability: The flowability is evaluated according to the standard ISO 6186. This consists in measuring the flow time of a given amount of powder through a funnel, the outlet diameter of which is set at 25 mm. The shorter the time, the better the powder flows.

Density:

The “bulk” density of the powder was measured in the following manner. A 250 ml graduated cylinder was filled with the powder. The exact volume and the mass are measured, from which the density is deduced. The density was obtained by making the cylinder previously filled for the measurement of the bulk density undergo a series of controlled vertical impacts (amplitude, frequency).

Characterization of the Test Specimens after Sintering

Mechanical Properties:

The mechanical properties of the sintered test specimens were measured using a Zwick 3 universal testing machine equipped with a 10 kN load cell. The displacement was measured using an optical extensometer. The rate of displacement was set at 5 mm/min.

Degradation of the PVDF in the Sintered Test Specimens:

The degradation of the PVDF was evaluated by measurement of the molar masses by GPC and estimation of a content of gel/insolubles.

GPC Analysis:

The molar masses before and after passing through the machine were measured by GPC using a Waters analysis chain equipped with a P600 pump, a Wisp 717Plus injector and a Waters 2414 RID refractometer detector. The temperature of the columns is regulated at 50° C. The sample to be analyzed is dissolved in DMSO+0.1 M NaNO₃ at a concentration of 2 g/l over 4 h at 95° C. The solution is then filtered using an ACRODISC GHP Polypropylene filter with a diameter of 25 mm and a porosity of 0.45 μm. The masses are expressed as PMMA equivalent. The insoluble fraction is estimated by comparing the intensity of the signal of the refractometer to that of a completely soluble PVDF.

The crystallinity of the test specimens after sintering was evaluated by DSC and x-ray diffraction.

Properties of the Powder

The hydrophobic silica enables the powder to flow through the orifice of the funnel. In this test, a flow time of 7 seconds is considered to be a sign of very good flowability. Without silica or additivated with hydrophilic silica FA2, the powder does not flow and cannot be used as is in the sintering process due to this poor flowability. The results are presented in table 1.

TABLE 1

| | Flow | Bulk | Tapped |
|---|---|---|---|
| | time (s) | density | density |
| PVDF powder not additivated | Does not flow | 0.651 | 0.905 |
| with silica | | | |
| PVDF powder additivated | 7 s | 0.726 | 0.955 |
| with hydrophobic silica FA1 | | | |
| PVDF powder additivated | Does not flow | 0.651 | 0.815 |
| with hydrophilic silica FA2 | | | |

Passage of the PVDF Powder Additivated with Hydrophobic Silica Through the Sintering Machine:

Tensile test specimens of ISO 527 1BA and 1A type were produced by sintering with a Formiga P100 laser sintering machine from EOS. The conditions for passage through the machine were the following:
Contour speed=1500 mm/s
Hatching speed=2500 mm/s
“Beam offset” hatching=0.15 mm.

The operating conditions are summarized in table 2 below:

TABLE 2

| Temperature of the | Temperature of | | |
|---|---|---|---|
| exposure chamber | the shrinkage | Energy density | Laser power |
| (° C.) | chamber (° C.) | (mJ/mm²) | (W) |
| 152° C. | 135° C. | 35 | 13.13 |
| 152° C. | 135° C. | 40 | 15 |
| 152° C. | 135° C. | 43 | 16.125 |

The characterization of the PVDF composition according to the invention according to the methods indicated above made it possible to obtain the results that appear in table 3.

TABLE 3

| | Temperature of | Energy | | | | |
|---|---|---|---|---|---|---|
| | the exposure | density | Mn | Mw | Refractometric | Fraction of |
| | chamber (° C.) | (mJ/mm²) | (g/mol) | (g/mol) | signal K(RI) | insolubles |
| PVDF powder | — | — | 82300 | 219000 | 87.8 | 0% |
| 1BA test | 152° C. | 43 | 81300 | 220200 | 88.4 | 0% |
| specimen of | | | | | | |
| sintered PVDF | | | | | | |

These results show that no degradation of the PVDF, evaluated with respect to the size of the PVDF chains or to the presence of insolubles, was observed by GPC.

Heat Treatment of the Powder

Formulation of the powder with silica: 0.2% by weight of Cab-o-sil TS610 silica are mixed with the PVDF powder using a rapid mixer.

The PVDF powder optionally additivated with silica undergoes various heat treatments:
8 h at 150° C.
8 h at 155° C.

The heat treatment is carried out statically by depositing the powder in a container which is placed in an oven.

The propensity of the powder to “cake” is evaluated using a mechanical compression test at ambient temperature. The test consists in filling hollow metal cylinders having an internal diameter of 15 mm and a height of 2 cm with the test powder. The metal cylinders act as a mold. Once filled, the cylinders are placed in an oven at the temperature for evaluating the caking, namely 150° C., 155° C. or 160° C. for 8 hours. The cylinders are taken out of the oven and left to cool to ambient temperature. Next, a powder “cake” is obtained by removing the metal cylinder. This powder cake is then placed between the jaws of a universal testing machine in order to undergo a compression test. The compressive force is recorded as a function of the displacement of the jaws. The maximum force reached during the compression test is recorded. All of the powders tested are compared to this criterion.

The test conditions are collated in table 4 below. The results are expressed in N.

TABLE 4

| Type of | | | | | | | | | |
|---|---|---|---|---|---|---|---|---|---|
| treatment of the | | | | | | | | | |
| powder before | | | | | | | | | |
| caking test | | | | | | | | | |
| Temperature of | No heat treatment | | | 8 h in an oven at 150° C. | | | 8 h in an oven at 155° C. | | |
| the caking test | 150° C. | 155° C. | 160° C. | 150° C. | 155° C. | 160° C. | 150° C. | 155° C. | 160° C. |
| PVDF | 0.38 | 0.99 | 2.66 | — | 0.58 | 2.25 | — | — | — |
| PVDF + 0.2% | 0.14 | 0.56 | 2.23 | — | 0.07 | 1.51 | — | 0.18 | 0.87 |
| silica | | | | | | | | | |

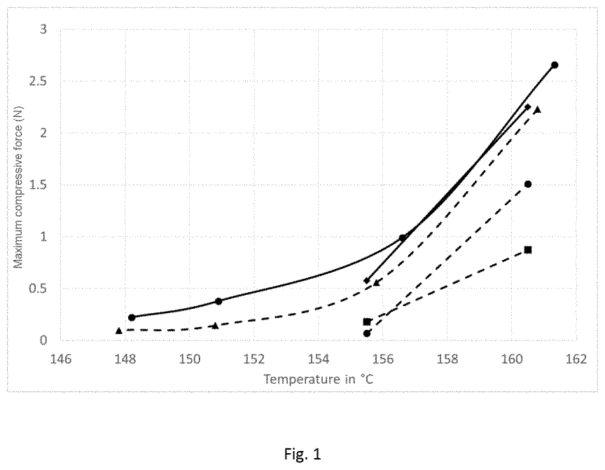

The data from the table are collated in the appended FIG. 1.

The solid-line curve with a solid circle symbol represents the maximum compressive force as a function of the temperature of a PVDF powder not additivated with silica and that has not undergone any heat treatment before the caking tests.

The solid-line curve with a diamond symbol represents the maximum compressive force as a function of the temperature of a PVDF powder not additivated with silica and that has undergone a heat treatment of 8 h at 150° C. before the caking tests.

The dotted-line curve with a solid triangle symbol represents the maximum compressive force as a function of the temperature of a PVDF powder additivated with 0.2% silica and that has not undergone any heat treatment before the caking tests.

The dotted-line curve with a solid circle symbol represents the maximum compressive force as a function of the temperature of a PVDF powder additivated with 0.2% silica and that has undergone a heat treatment of 8 h at 150° C. before the caking tests.

The dotted-line curve with a solid square symbol represents the maximum compressive force as a function of the temperature of a PVDF powder additivated with 0.2% silica and that has undergone a heat treatment of 8 h at 155° C. before the caking tests.

The results indicated in FIG. 1 show that the higher the measured compressive force, the more this reveals the propensity of the powder to agglomerate. Above 2 N, the agglomeration of the powder is notable and partially irreversible under a moderate mechanical stress. At 160° C., the powders additivated with silica and heat-treated at 150° C. or 155° C. have a compressive force less than or equal to 1.5 N and do not display any signs of irreversible agglomeration. This behavior offers the possibility of having recourse to higher sintering temperatures than an untreated PVDF powder, i.e. temperatures where the crystallization kinetics of the PVDF are slower.

Furthermore, it has been observed that the heat treatment of a composition according to the invention increases the tapped and bulk densities of the powder, as shown by the results that appear in table 5 (expressed in g/cm³). This property is favorable for laser sintering since it makes it possible to have a denser and more homogeneous powder bath during the construction of the parts.

TABLE 5

| | Bulk density | Tapped density |
|---|---|---|
| PVDF powder | 0.651 | 0.905 |
| PVDF powder treated | 0.726 | 0.955 |
| 8 h at 150° C. | | |
| PVDF powder + 0.2% | 0.745 | 1.035 |
| silica treated 8 h | | |
| 150° C. | | |

1. A composition in powder form comprising a thermoplastic fluoropolymer and a flow agent, said composition having undergone heating at a temperature ranging from Tₘ−40° C. to Tₘ−5° C., Tₘ being the melting temperature of the thermoplastic polymer measured by DSC.

2. The composition of claim 1, having a compressive force of less than 2 N, as measured by a compression test carried out on the powder that has undergone the heat treatment.

3. The composition of claim 1, wherein the fluoropolymer is a homopolymer or a copolymer comprising at least one monomer selected from the group consisting of: vinyl fluoride; vinylidene fluoride; trifluoroethylene; chlorotrifluoroethylene; 1,2-difluoroethylene; tetrafluoroethylene; hexafluoropropylene; perfluoro(alkyl vinyl) ethers; perfluoro(1,3-dioxole); perfluoro(2,2-dimethyl-1,3-dioxole); the product of formula CF₂═CFOCF₂CF(CF₃)OCF₂CF₂X wherein X is SO₂F, CO₂H, CH₂OH, CH₂OCN or CH₂OPO₃H; the product of formula CF₂═CFOCF₂CF₂SO₂F; the product of formula F(CF₂)nCH₂OCF═CF₂ wherein n is 1, 2, 3, 4 or 5; the product of formula R₁CH₂OCF═CF₂ wherein R₁ is hydrogen or F(CF₂)ₘ and m is equal to 1, 2, 3 or 4; the product of formula R₂OCF═CH₂ wherein R₂ is F(CF₂)p and p is 1, 2, 3 or 4; perfluorobutyl ethylene (PFBE); 3,3,3-trifluoroprop ene and 2-trifluoromethyl-3,3,3-trifluoro-1-propene.

4. The composition of claim 1, wherein said fluoropolymer is a polymer comprising units derived from vinylidene fluoride, and is chosen from polyvinylidene fluoride homopolymer and copolymers comprising at least 50 mol % of units derived from vinylidene fluoride units and the remainder of the units derived from at least one other comonomer chosen from: vinyl fluoride; trifluoroethylene; chlorotrifluoroethylene; 1,2-difluoroethylene; tetrafluoroethylene; hexafluoropropylene; perfluoro(alkyl vinyl) ethers; perfluoro(1,3-dioxole); perfluoro(2,2-dimethyl-1,3-dioxole), and mixtures thereof.

5. The composition of claim 1, wherein said fluoropolymer is chosen from the groups consisting of copolymers of ethylene and chlorotrifluoroethylene, of ethylene and tetrafluoroethylene, of hexafluoropropylene and tetrafluoroethylene, of tetrafluoroethylene and a monomer from the family of perfluoro(alkyl vinyl) ethers.

6. The composition of claim 1, wherein said fluoropolymer has a viscosity of less than or equal to 1600 Pa·s, measured at a temperature of 232° C. and at a shear rate of 100 s⁻¹ according to the standard ASTM D3825.

7. The composition of claim 1, wherein the fluoropolymer powder has a particle size defined by a Dv50 of less than or equal to 100 μm.

8. The composition of claim 1, wherein said fluoropolymer has a number-average molecular mass ranging from 5 kDa to 200 kDa.

9. The composition of claim 1, wherein said flow agent is selected from the group consisting of: precipitated silicas, fumed silicas, vitreous silicas, pyrogenic silicas, vitreous phosphates, vitreous borates, vitreous oxides, amorphous alumina, titanium dioxide, talc, mica, kaolin, attapulgite, calcium silicates, alumina and magnesium silicates.

10. The composition of claim 9, wherein said flow agent is a hydrophobic fumed silica.

11. The composition of claim 1, wherein the weight proportion of flow agent is between 0.01% and 5% of the total weight of the composition.

12. The composition of claim 1, consisting of a fluoropolymer and a flow agent.

13. The composition of claim 1, further comprising up to 50% by weight of one or more additives selected from the group consisting of dyes, pigments for coloring, pigments for infrared absorption, carbon black, fire-retardant additives, glass fibers, carbon fibers, antioxidant stabilizers, light stabilizers, impact modifiers, antistatic agents and flame retardants.

14. A process for manufacturing a three-dimensional object, said process comprising the steps of providing the composition in powder form of claim 1 and laser sintering said composition to obtain a three-dimensional object.

15. (canceled)

16. A three-dimensional object obtained by the process of claim 14.

17. The composition of claim 1, having a compressive force of less than 1.5 N, as measured by a compression test carried out on the powder that has undergone the heat treatment.

18. The composition of claim 1, wherein the fluoropolymer is a homopolymer or a copolymer comprising at least one monomer selected from the group consisting of perfluoro(methyl vinyl) ether, perfluoro(ethyl vinyl) ether and perfluoro(propyl vinyl) ether.

19. The composition of claim 1, wherein the fluoropolymer powder has a particle size defined by a Dv50 of between 25 and 80 micrometers.

20. The composition of claim 1, wherein said fluoropolymer has a number-average molecular mass ranging from 5 kDa to 150 kDa.
